(19) United States
(12) Patent Application Publication
(10) Pub. No.: US 2024/0261869 A1
(43) Pub. Date: Aug. 8, 2024

(54) Cutting Insert

(71) Applicant: VARGUS LTD, Nahariya (IL)

(72) Inventors: Baruch Books, Kfar Kradim (IL); Evgeni Tulchinsky, Haruvin (IL); Rafael Morgulis, Karmiel (IL)

(21) Appl. No.: 18/565,203

(22) PCT Filed: Jun. 3, 2022
(86) PCT No.: PCT/IB2022/055188

§ 371 Date: Nov. 29, 2023

Related U.S. Application Data
(60) Provisional application No. 63/197,457, filed on Jun. 6, 2021.

(51) Int. Cl. B23B 27/16

(52) U.S. Cl. CPC B23B 27/1611

(57) ABSTRACT

Disclosed is a cutting insert having a generally polygonal shaped primary body including a primary body base connected to an opposing, generally parallel and similarly-shaped body face through a plurality of flank portions extending there between. The Cutting insert further includes at least one cutting protrusion merging therewith and extending away there from the primary body. The at least one cutting protrusion includes a protrusion base which is generally coplanar and merges with the primary body base. The at least one cutting protrusion further includes a rake face in a direction opposite to the protrusion base, and a protruding flank extending there between the protrusion base and the rake face. The at least one cutting protrusion further includes a tip flat extending between a rake front at a protrusion tip towards a rake root portion, adjacent the primary body.

### CROSS-REFERENCE TO RELATED APPLICATIONS

This application is national-stage application of PCT/IB2022/055188, filed on Jun. 3, 2022, which claims the benefit of U.S. provisional patent application No. 63/197,457, filed on Jun. 6, 2021, the contents of which are incorporated by reference in their entirety.

### BACKGROUND

Background of the disclosure is for informational purposes only and does not necessarily admit that subsequently mentioned information and/or publications are prior art.

Generally, cutting inserts [herein below “Cutting inserts” ] are used in turning operations to carve screw thread[s] onto an internal and/or external envelope of a generally cylindrical work piece. However, work pieces may be of any desired cross-section shape.

Threading operations are rather demanding on inserts, holders, and machines, demanding good chip control, thread quality and consistency, low insert wear [to help thread quality and consistency], and long tool life. However, threading operation exerts high machining forces concentration, at the weakest area of the insert, which is the cutting tip.

To reduce cutting loads, prior-art groove/thread inserts are shaped with a “positive” land, immediately next to a” cutting edge thereof. See, for example, U.S. Pat. No. 7,909,546B2, disclosing, inter-alia, “ . . . the present invention employs a thread cutting insert . . . an inclined face of the first step that continues to the thread cutting edge 7 is a narrow positive land with a moderate inclination angle . . . ” [See FIG. 3, Prior Art U.S. Pat. No. 7,909,546B2].

Prior-art publication, discloses, inter-alia, “ . . . an insert for thread cutting . . . ”, Prior-Art, JP2006123041A, shows a perspective view a detail plan view of a cutting tip and cross-sections through the cutting tip showing an acute-angled land.

While acute angled/positive rake lands offer good chip removal initially, they suffer from heat concentration, and lower strength, the sharper the acute angle becomes. They may dull faster, thus lowering consistency of thread cutting, and lowering tool and insert lives.

Therefore, there has been increasing interests towards using “negative” land, immediately next to a “cutting edge” thereof due to certain advantages provided by them such as for example, such negative lands offers a strong tool tip, which makes the tool more resilient under impact loading, resists plastic deformation at high cutting temperature, and provides longer tool life.

However, there has been certain shortcomings observed due to these negative lands. For example, such negative cutting angle increases cutting forces, and pressure associated therewith, which may, result in an unwanted movement of the insert relative to the pocket, in particular against a rotational movement about a centre axis when using a central clamping screw.

Therefore, it is an intention of the present disclosure to provide a cutting insert having negative land, in particular for threading operations, which while allowing a high rigidity of the cutting tool, avoids any shifting or rotation thereof during use such that a high accuracy in positioning of the cutting edges against the work-piece, is maintained.

### SUMMARY

One aspect of the present disclosure generally concerns an exemplary cutting tool for performing thread turning operations. The cutting tool includes a tool holder and a thread cutting insert adapted to be securely engaged thereon to the tool holder. The tool holder includes a holder body defined by a top face, a bottom face and two opposed longitudinally extending side faces extending generally parallel to each other between a front end and a back end. Further, the tool holder includes a recess defining an insert pocket configured within one of its side faces. The insert pocket includes a base support surface and a plurality of side support walls extending upwardly there from.

The Cutting insert includes a generally polygonal shaped primary body having a primary body base connected to an opposing and similarly-shaped body face through a plurality of flank portions extending there between. The cutting insert further includes at least one cutting protrusion merging therewith and extending away there from the primary body. The at least one cutting protrusion includes a protrusion base which is generally coplanar and merges with the primary body base. The cutting protrusion further includes a rake face in a direction opposite to the protrusion base, and a protruding flank extending there between the protrusion base and the rake face. The cutting protrusion further includes a tip flat extending between a rake front at a protrusion tip towards a rake root portion, adjacent the primary body. The cutting protrusion is angled relative to the primary body such that an angle between the rake face and a normal to the primary body base is smaller than an angle between the same normal and the tip flat of the cutting protrusion.

In operation, the Cutting insert is releasably secured into said recess by one or more clamping means such as a center screw threadably engageable with a transverse bore in the holder, such that the at-least one cutting protrusion extends out of the holder and is adapted to perform a threading operation onto a work-piece.

Preferably, the Cutting insert includes three cutting protrusions and the primary body is generally triangular in shape.

Additionally, the plurality of flank portions of the Cutting insert includes at-least one rear flank portion generally opposing one of the cutting protrusions and facing away there from.

Further, the rear flank portion includes a base flank extending away from the body base towards the body face, and a top flank extending away from the body face towards the body base to meet the base flank at a middle corner. The base flank is positioned at an angle β relative to the body base to define a base angle. The top flank is positioned at an angle γ relative to the body base to define a face angle such that the angle β is generally larger the angle γ.

Particularly, the base angle β ranges between 60° and 120° and preferably ranges between 86° to 95°

Further particularly, the face angle γ ranges between 30° and 80° and preferably ranges between 36° to 45°

Preferably, at least one of the side support walls and the base support surface of the insert pocket defines an acute angle (α) there between.

Further, the acute angle (α) ranges between is 25° and 85° and preferably ranges between 37° to 46° such that a top flank of at least one of the rear flank portions is abutted and/or locked against the corresponding side support wall. Such an abutment and/or locking is similar to a dove tail locking mechanism and may therefore be called as a dovetail abutment.

Particularly, the protruding flank includes a first flat flank surface extending towards a second flat flank surface through a central arc shaped flank surface.

Optionally, the protrusion tip extended towards the flank is honed for a smooth edging.

Preferably, the protrusion tip is defined only by the central arc shaped flank surface of the protruding flank.

Alternatively, the protrusion tip is defined by the entire protruding flank including the first flat flank surface, the second flat flank surface and the central arc shaped flank surface.

Another aspect of the present disclosure concerns a Cutting insert having a generally polygonal shaped primary body including a primary body base connected to an opposing, generally parallel and similarly-shaped body face through a plurality of flank portions extending there between. The cutting insert further includes at least one cutting protrusion merging therewith and extending away there from the primary body. The at least one cutting protrusion includes a protrusion base which is generally coplanar and merges with the primary body base. The at least one cutting protrusion further includes a rake face in a direction opposite to the protrusion base, and a protruding flank extending there between the protrusion base and the rake face. The rake face generally includes a tip flat extends between a rake front at a protrusion tip towards a rake root portion, adjacent the primary body. The cutting protrusion is angled relative to the primary body such that an angle between the rake face and a normal to the primary body base is smaller than an angle between the same normal and the tip flat of the cutting protrusion.

Further, the plurality of flank portions of the cutting insert includes at least one rear flank portion generally opposing one of the cutting protrusions and facing away there from. Furthermore, the rear flank portion includes a base flank extending away from the body base towards the body face, and a top flank extending away from the body face towards the body base to meet at a middle corner, with the base flank. The base flank is positioned at an angle β relative to the body base to define a base angle. The top flank is positioned at an angle γ relative to the body base to define a face angle such that the angle β is generally larger the angle γ.

Particularly, the base angle β ranges between 60° and 120° and preferably ranges between 86° to 95°

Further particularly, the face angle γ ranges between 30° and 80° and preferably ranges between 36° to 45°

In addition to the exemplary aspects and embodiments described above, further aspects and embodiments will become apparent by reference to the figures and by study of the following detailed descriptions.

### BRIEF DESCRIPTION OF THE DRAWINGS

Exemplary and/or illustrative embodiments of the present disclosure will be presented herein below in the following figures, by way of example only. The present disclosure may be best understood from the following detailed description when read in connection with the accompanying drawings. In the drawings, like portions have the same reference numerals. Modifications or alteration of a generally similar portion and/or element, will be identified with the same numeral, appended by a letter, such as Hand 77, left hand 77l, right hand 77r.

It should be emphasized that according to common practice, various features of the drawings are not drawn to scale unless otherwise indicated. On the contrary, dimensions of various features, and/or the features themselves, may be expanded and/or reduced and/or roughly shown and/or omitted entirely, to show details of particular components, in a purpose that the present disclosure may become more fully understood from the detailed description and the accompanying schematic figures. Reference will now be made to the accompanying drawings, in which:

FIG. 1 illustrates an exemplary cutting tool holder holding the cutting insert in accordance to an embodiment of the current disclosure;

FIG. 2a illustrates a general schematic perspective view of a cutting insert in accordance to a first preferred embodiment of the current disclosure;

FIG. 2b illustrates a general schematic perspective view of a cutting in accordance to a second preferred embodiment of the current disclosure;

FIG. 3a illustrates a general schematic top view of the cutting insert of the first exemplary-only embodiment shown in FIG. 2a;

FIG. 3b illustrates a general schematic top view of the cutting insert of the first exemplary-only embodiment shown in FIG. 2b;

FIG. 4 illustrates a general schematic side view of the cutting insert of the current disclosure;

FIG. 5a illustrates an exemplary positioning of the Cutting insert within an insert pocket of the cutting tool holder of the exemplary-only embodiment of the current disclosure;

FIG. 5b illustrates another exemplary positioning of the Cutting insert within insert pocket insert pocket of the cutting tool holder of the another exemplary-only embodiment of the current disclosure;

FIG. 5c illustrates yet an exemplary positioning of the Cutting insert within insert pocket of the cutting tool holder of the another exemplary-only embodiment of the current disclosure;

FIGS. 6a-6b illustrate machining of a work piece in accordance to an exemplary-only embodiment of the current disclosure.

### DETAILED DESCRIPTION

As required, a schematic, exemplary-only embodiment of the present disclosures disclosed herein; however, it is to be understood that the disclosed embodiment is merely exemplary of the present disclosure, which may be embodied in various and/or alternative forms. Specific structural and functional details disclosed herein are not to be interpreted as limiting, but merely as a basis for the claims and as a representative basis for teaching one skilled in the art to variously employ the present disclosure in virtually any appropriately detailed structure.

Aspects, advantages and/or other features of the exemplary embodiment of the disclosure will become apparent in view of the following detailed description, which discloses non-limiting embodiments of the disclosure. In describing exemplary embodiments, specific terminology is employed for the sake of clarity. However, the embodiments are not intended to be limited to this specific terminology. It is to be understood that each specific portion includes all technical equivalents that operate in a similar manner to accomplish a similar purpose.

Exemplary embodiments may be adapted for many different purposes and are not intended to be limited to the specific exemplary purposes set forth herein. Those skilled in the art would be able to adapt the exemplary-only embodiment of the present disclosure, depending for example, on the intended use of adapted embodiment. Moreover, examples and limitations related therewith brought herein below are intended to be illustrative and not exclusive. Other limitations of the related art will become apparent to those of skill in the art upon a reading of the following specification and a study of the related figures.

The present application discloses a cutting tool holder and a cutting insert for performing a threading operation onto a work piece. In accordance with the present invention, the cutting insert is a hard, wear resistant cutting insert having a negative rake land, that allows the possibility of providing a high strength for working on generally hard materials such as, for example Including, but not limited to, HSS—high speed steel, hard alloys, titanium alloys, etc. The cutting insert further includes a dovetail abutment/locking mechanism so as to securely hold it within an insert pocket of a tool holder such that a shift and/or movement of the insert within the tool holder is avoided and thereby providing high rigidity operation while maintaining an accurate positioning and reducing a cycle time. Such an insert while preferably adapted along within its own holder, may also be used with any conventional holder known in the art and suitable to use therewith. It is to be understood that unless otherwise indicated this invention need not be limited to any specific material and/or operation. Moreover, it should be understood that embodiments of the present invention may be applied in combination with various known tools holders, and/or pockets, to achieve any desired application. It must also be noted that, as used in this specification and the appended claims, the singular forms “a,” “an” and “the” include plural referents unless the context clearly dictates otherwise. Thus, for example, the term “an opening” is intended to mean a single opening or a combination of openings, “a support wall” is intended to mean one or more support walls, or a combination thereof.

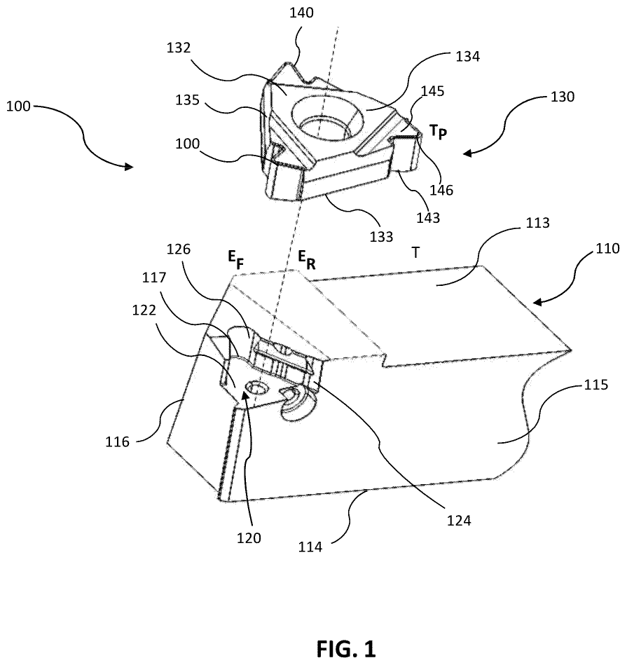

Referring now to FIG. 1, a first, exemplary-only, illustrative embodiment of the present disclosure demonstrates a descriptive-only, exemplary, cutting tool 100. The cutting tool 100 includes a descriptive-only, exemplary, tool holder 110. The tool holder 110 is of a, generally elongated prism shape, extending from a front end E_{F} generally rearwardly towards a rear end E_{R} of the tool holder 110. The tool holder 110 further includes a first tail T extending away forwardly in a direction generally away from the rear end E_{R} and may be adjustably located onto a machining apparatus [not shown] by any known and/or discovered, means.

The tool holder 110 includes a holder body 112 defined by a top face 113, a bottom face 114, and two opposed longitudinally extending side faces 115, 116 extending generally parallel to each other between the front end E_{F} and the rear end E_{R}. Further, the tool holder includes a recess 117 defining an insert pocket 120, configured within one of its side faces 115, 116. The insert pocket 120 includes a base support surface 122 and a plurality of side support walls 124, 126, extending upwardly there from.

The cutting tool 100 further includes a cutting insert 130 adapted to be releasably held, during operation, by the dedicated, descriptive-only, exemplary, tool holder 110. The Cutting insert 130 comprises a primary body 132. The primary body 132 is a generally polygonal shaped body, illustrated as a triangular shaped body as an exemplary embodiment. The primary body 132 is defined by a primary body base 133 connected to an opposing and similarly-shaped primary body face 134 through a plurality of flank portions 135 extending there between. The Cutting insert 130 further includes a plurality of, and at least one cutting protrusions 140 merging therewith and extending away there from the primary body 132. Each of the plurality of cutting protrusion 140 includes a protrusion base 143 which is generally coplanar and merges with the primary body base 133. Further, the cutting protrusions 140 further includes a rake face 145 in a direction generally parallel and opposite to the protrusion base 143, and a protruding flank 146 extending there between the protrusion base 143 and the rake face 145. The rake face 145 generally includes a tip flat 148 extends between a rake front R_{F} at a protrusion tip T towards a rake root portion R_{R}, adjacent the primary body 132. The protrusion is angled relative to the primary body such that a rake angle Ø [not shown] between the rake face 145 and a normal N to the primary body base 133 is smaller than a land angle Ω [not shown] between the same normal N and the tip flat 146 of the cutting protrusion 140.

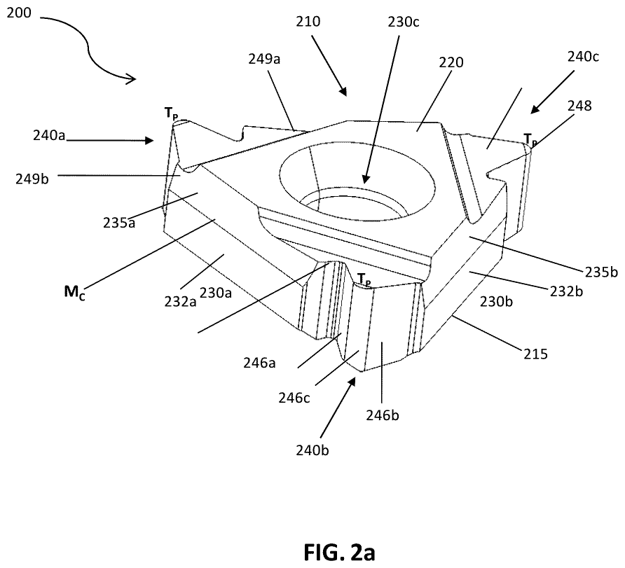

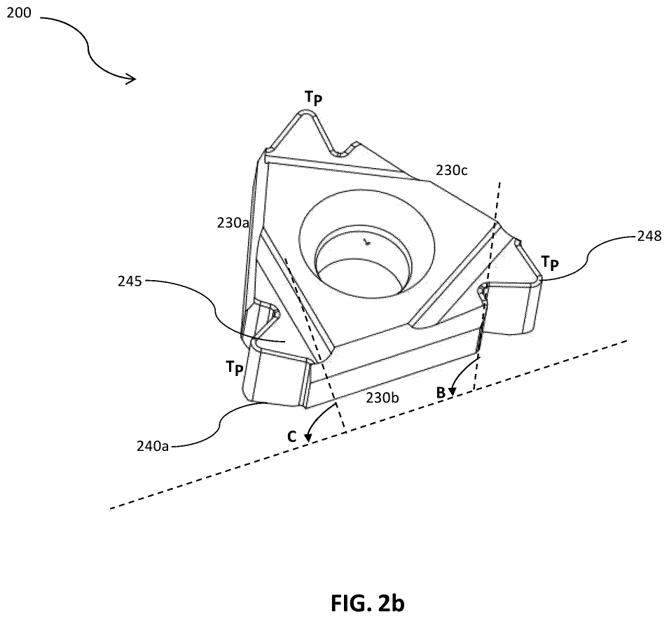

FIGS. 2 to 4, illustrate an exemplary cutting insert 200 of the present invention in accordance to various embodiments. As disclosed earlier, the cutting insert 200 includes a generally polygonal-shaped insert primary body 210. In the disclosed example, the primary body 210 is in the shape of a triangular polygonal shape. However, in other embodiments, the polygonal shape may be in the form of any possible shape such as for example, a rectangular, a square, a rhombic, or any other similar shape. The Cutting insert 200 is generally formed of a hard, abrasion resistant material, such as including but not limited to a tungsten carbide, metallic compounds, HSS, ceramic based cutting materials such as ceramic materials, ceramic alloys and/or any other known or discovered hard and tough material and/or compound”. The cutting inserts material may be coated with one or more materials such as including but not limited to diamond, and/or diamond-like compounds, including thin wafers of hard material disposed onto cutting material, CBN (Cubic Boron Nitride) and/or any other known or discovered hard and tough substance suitable to be used as a coating material. The cutting insert 200 is generally formed by press-molding and sintering a powdered cutting material such as tungsten carbide. However, in some embodiments, the cutting insert 200 may also be produced by injection molding. In yet other embodiments, the cutting insert 200 may be produced using any suitable mechanism conventionally known in the art.

The primary body 210 includes a generally triangular shaped primary body base 215 connected to an opposing and generally parallel primary body face 220 through a plurality of flank portions 230 extending there between. The number of rear flank portions 230 is generally same as a number of sides of the primary body 210. For example, within the illustrated examples, there are three flank portions 230a, 230b and 230c. Each of the rear flank portions 230a, 230b and 230c includes a base flank 232a, 232b, 232c[232 and corresponding flanks not visible in FIG. 2a], respectively, extending away from the primary body base 220 towards the primary body face 215, and a top flank 235a, 235b, 235c extending away from the primary body face 215 towards the primary body base 220 to meet at the corresponding base flank 232 at corresponding middle corner portion Mc. Each of the base flanks 235a, 235b, 235c is positioned at an angle relative to the primary body base 220 defined as a base angle β. Each of the top flanks 232a, 232b, 232c, is positioned at an angle relative to the body base 220 defined as a face angle γ such that the angle β is generally larger than the angle γ. In one embodiment, the base angle β ranges between 60° and 120° and preferably ranges between 86° to 95°. Further within such embodiments, the face angle γ ranges between 30° and 80° and preferably ranges between 36° to 45°.

The Cutting insert 200 further includes at least one and preferably, three generally triangular shaped cutting protrusion 240a, 240b, 240c, merging therewith and extending away there from the primary body 215 such that each of the cutting protrusion 240a, 240b, 240c is positioned in a direction opposite to one of the rear flank portions 230a, 230b, and 230c and each of the two adjacent rear flanks 230a, 230b, and 230c are associated with one of the three cutting protrusions 240a, 240b, and 240c.

Each of the plurality of cutting protrusions 240a, 240b, 240c includes a protrusion base 243 which is generally coplanar and merges with the primary body base 220. The cutting protrusion 240 further includes a rake face 245 in a direction opposite to the protrusion base 243, and a protruding flank 246 extending there between the protrusion base 243 and the rake face 245. The rake face 245 generally includes a tip flat 248 extends between a rake front R_{F} at a protrusion tip T_{P} towards a rake root portion R_{R}, adjacent the primary body 210.

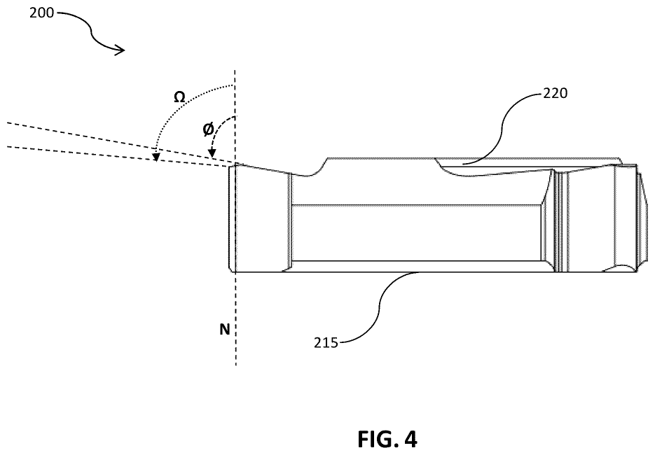

As illustrated in FIG. 4, the cutting protrusion 240 is angled relative to the primary body 210 such that a rake angle Ø between the rake face 245 and a normal N to the primary body base 220 is smaller than a land angle (Ω) between the same normal N and the tip flat 248 of the cutting protrusion 240. The land angle Ω is an acute angle generally ranging between is 10° and 850 and preferably ranges between 15° to 75°. The rake angle (Ø) ranges is also an acute angle generally ranging between is 20° and 65° and preferably ranges between 30° to 45°.

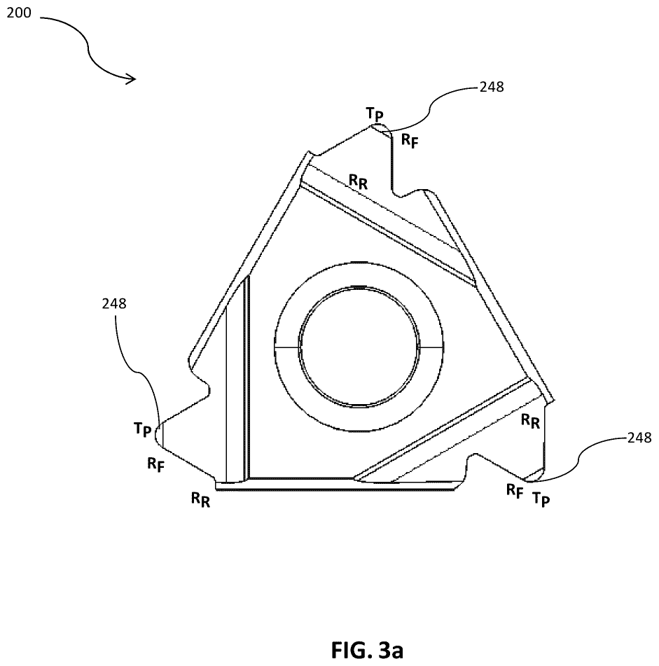

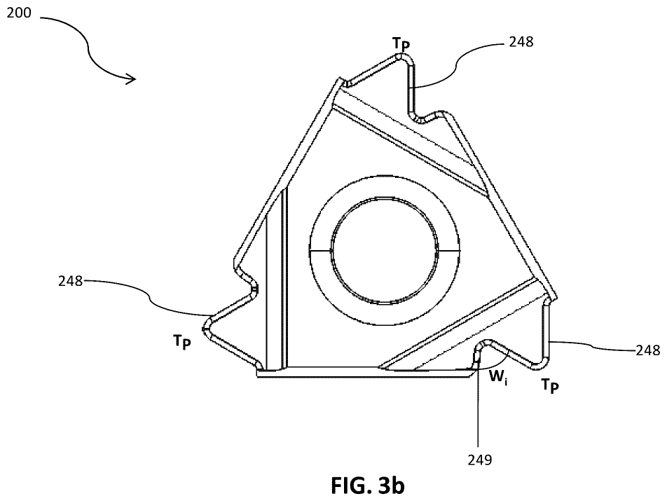

As illustrated in FIG. 2a, the protruding flank 246 includes a first flat flank surface 246a, connected to a second flat flank surface 246b through a central arc shaped flank surface 246c. Further, the tip flat 248 is extended towards the protruding flank 246 to define the protruding tip T_{P} which shall engage with and cut threads of a metallic work-piece (not shown). In a preferred embodiment as illustrated in FIGS. 2a and 3a, the protrusion tip T_{P} is defined only by the central arc shaped flank surface 246c of the protruding flank 246. However, in other embodiment as illustrated in FIGS. 2b and 3b, the protrusion tip T_{P} is defined by the entire surface of the protruding flank 246 including the first flat flank surface 246a, the second flat flank surface 246b and the central arc shaped flank surface 246c such that the protrusion tip T_{P} is defined at the entire periphery of the cutting protrusion 240. Such an embodiment is illustrated in FIG. 2b. Further, the flank surface 246a, and the 246c are connected to at least one of the adjacent rear flank portions 230 through a wiper edge 249. Such wiper edges 249 are generally tapered and forms an angle Wi with the corresponding flank surface 246.

In a preferred embodiment, the three cutting protrusions 240a, 240b, 240c are identical in shape and configuration. However, in some other embodiments, each of the cutting protrusions 240a, 240b, 240c is configured differently to perform a corresponding threading operation to achieve a different threading and/or grooving geometry, without deviating from the scope of the current disclosure. Further, in some embodiments, the Cutting insert 200 may comprise only one cutting protrusion 240, which is provided between two of the flank portions 230. Thus, the Cutting insert 200 is a 3-positions indexable insert having three different cutting protrusions 240, each having a corresponding protrusion tip T_{P}. Furthermore, in some embodiments, the each of the cutting protrusion may comprise a variable number of protruding tips T_{P}, in the form of a plurality of cutting teeth (not shown) configured onto each of cutting protrusion 240, which is provided between two of the rear flank portions 230. Accordingly, the Cutting insert 200 is a 3-positions indexable insert having three different cutting protrusions 240, each having a corresponding protrusion tip (s) T_{P}.

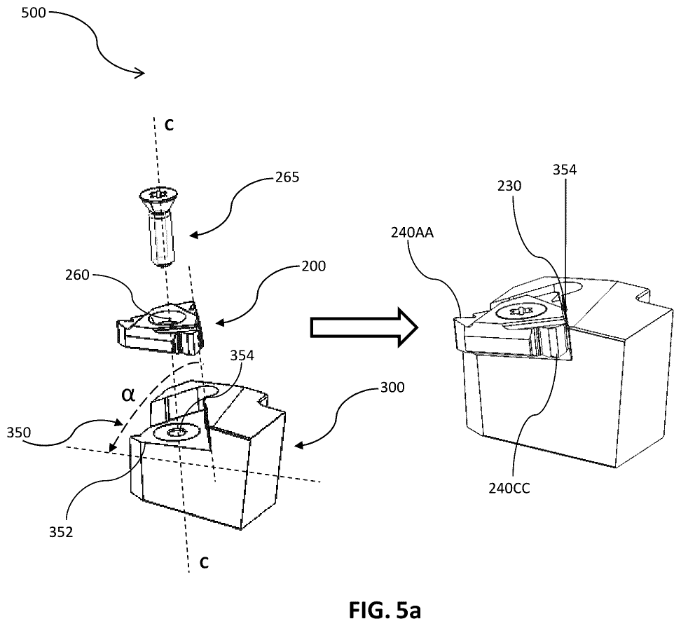

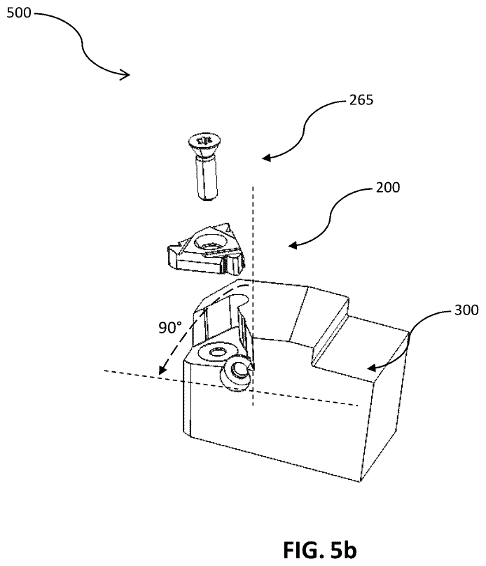

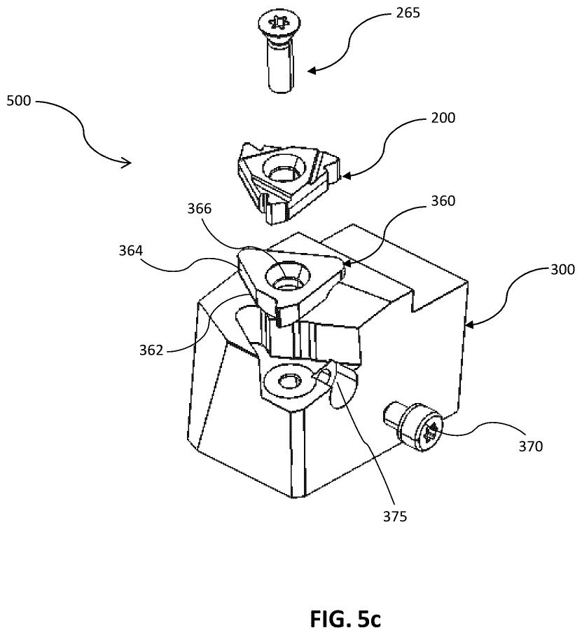

FIG. 5 illustrates an exemplary Cutting tool 600 comprising a tool holder 300 of the cutting tool 100 of the current disclosure, provided with an insert pocket 350, adapted to receive the Cutting insert 200 of the current disclosure.

As disclosed earlier, the Cutting insert 200 is adapted to be supported onto the tool holder 300. Accordingly, the insert 200 further includes one or more clamping mechanism 265 for enabling an engagement thereof with the tool holder. In some preferred embodiments, as illustrated, the Cutting insert 200 is provided with a central through hole 260 for receiving a clamping screw 265 there through such that a screw, fastening bolt, or the like, may be used to connect the insert 200 onto the recess/pocket 350 of the tool holder 300. In some embodiments, the insert 200 further includes a clamping wedge, provided for co-operating with the central clamping screw 265. In yet other embodiments, any conventionally known clamping mechanism may be utilized and accommodated within the insert 200 so as to securely and releasably engage it onto the tool holder 300.

Looping back to FIG. 5. the pocket 350 include a base support surface 352 shaped in accordance to the shape of the insert 200. The pocket 350 further includes one or more side support walls 354 extending there from the base support surface 352. The tool holder 300, including the insert pocket 350 is a one piece integral formation and is made of a material generally selected from one or more of but not limited to a machined steel or any other suitable hard material. The insert pocket 350 further includes a clamping hole 354 configured thereon the base support surface 352, adapted to receive the clamping screw 265 therein so as to hold the insert 200 onto the holder 300 at the pocket 350.

The Cutting insert 200 when positioned within the pocket 350, is adapted to present one of the cutting protrusion 240 as an active cutting protrusion 240AA, whereas the remaining cutting protrusions, referred to as passive cutting protrusions 240CC, are received within the pocket 350 such that one or more rear flank portions 230 of the Cutting insert 200 is abutted against the one or more side support walls 354.

In a preferred embodiment as illustrated in FIG. 5a, the one or more side support wall 354 is defined at an angle relative to the base support surface 352. Preferably, the one of the side support walls 354 and the base support surface 352 of the insert pocket 350 defines a pocket angle (α) there between. The pocket angle (α) is generally complementary and adapted to interact with a face angle γ of the top flank 235 so as to abut therewith, providing an end stop dovetail locking/abutment to the Cutting insert 200 at at least one of the rear flank portions 230, when positioned within the insert pocket 350.

Accordingly, the Cutting insert 200 is adapted to be inserted within the pocket 350 such that the primary body base 220 is positioned onto the bottom support surface 352 and the rear flank portions 230, and preferably, the top flanks 235 adjacent the passive cutting protrusions 240CC abuts against the side support walls 354 of the pocket 350 to provide a dovetail lock thereat. Such an arrangement and/or abutment between the insert 200 and the pocket 350 prevents any possibility of rotational and/or axial movement of the insert 200 about its central axis C during the use of the tool holder 300 thereby limiting any change in the position of the insert 200 during use and in turn offering a highly accurate threading operation by maintaining a desired axial and radial rake angle of the protruding tip T_{P} against the work piece. Such a preferred embodiment eliminates the need for additional structures such as a clamp to positively lock the insert 200 and also reduces the possibility of failure due to the clamping screw 265.

However, in other embodiment as illustrated in FIG. 5b, the support wall 354 is defined at an angle of 90 degree relative to the base support surface 352. The pocket angle (α) in such embodiments, is generally complementary and adapted to interact with the base angle β of the base flank 232 so as to abut therewith, providing an end stop to the Cutting insert 200 at at least one of the rear flank portions 230, when positioned within the insert pocket 350. The pocket angle (α) in such embodiments ranges between 80° and 90°. In yet other embodiments, the support wall 354 is defined at any angle relative to the base support surface 352 and still gets abutted to the base flank.

Accordingly, the insert 200 when positioned within the pocket 350, the primary body base 220 abuts the base support surface 352. However, in some embodiments as illustrated in FIG. 5c, the cutting tool 100 includes a supporting element 360 adapted to support the cutting insert 200 of the current disclosure, on to generally available tool holders 300. Such supporting elements 360 in some instances is provided in the form of an anvil 360 adapted to be positioned between the cutting insert 200 and the base support surface 352 of the pocket 350. Further in some instances, the anvil 360 is adapted to tilt the insert 200 at a predetermined angle as desired for the threading operation. However, in other embodiments, the supporting elements 360 may be in the form of a shim having a bottom shim surface 362 towards a plurality of side shim walls 364. In some embodiments, the plurality of shim walls 364 includes at least one angular wall extending from a plane of the bottom shim surface 362 at a predetermined angle such that at least one of the support walls 354 of the insert pockets 350 is abutted thereto. In all such embodiments, the supporting element 360 includes a screw hole 366 configured onto its bottom surface 362 so as to receive the clamping screw 265 there through.

In a preferred embodiment as illustrated in FIG. 5c, the supporting element 360 is placed in the insert pocket 350 and locked in the pocket 350 using a lock screw 370, which is inserted via a side hole 375 provided on the side face of the holder 300. Thereafter, the insert 200 is placed on top of the supporting element 360 and the clamping screw 265 is inserted in the through hole of the insert 200 and tightened such that the primary body 210 is located onto the insert pocket 350 through the supporting element 360.

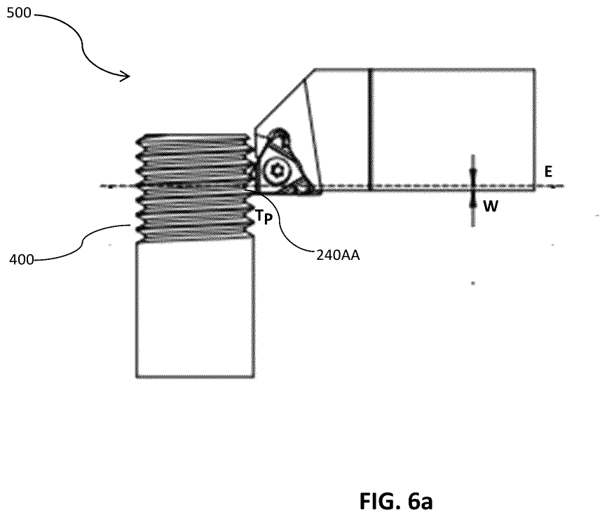

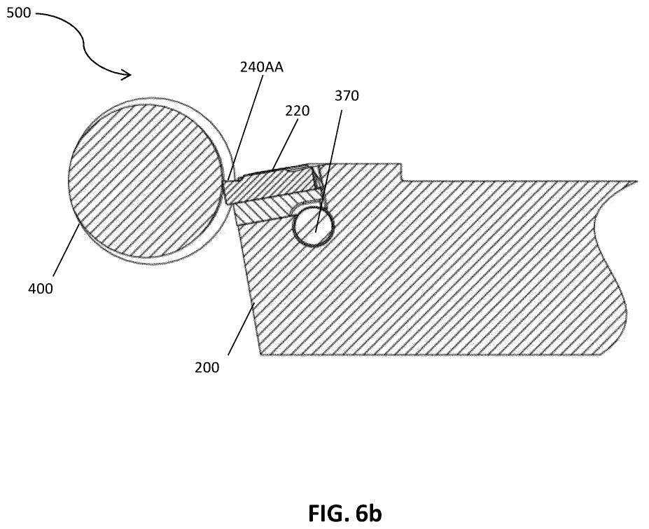

In operation, as illustrated in FIGS. 6a and 6b, the insert 200 is fixedly secured within the pocket 350 of the tool holder 300 such that the active cutting protrusion 240AA at least partially projects away there from an external axial boundary E (shown by a dotted line in FIG. 6a) of the holder 300 and the Projecting tip T_{P} is abutted against a suitable work piece 400, such as a round bar. A width W of a projecting portion generally ranges between 0.5 mm to 1.5 mm and preferably is approximately 1.00 mm. However, the width W may be adjusted on the basis of a depth and/or geometry of the threading to be formed onto the work-piece 400. The work-piece 400 is fed at a predetermined speed in a thread chasing direction, such that the protrusion tip T_{P} of the active cutting protrusion 240AA penetrates a stock material from the work-piece 400, carving away, material chips such that a thread/groove is formed by the Projecting tip T_{P} in the work-piece 400. Accordingly, the work-piece 400 may be fed out in a plurality of cycles so that a thread is formed on the circumferential surface of the work-piece 400 by the protrusion tip T_{P}, and a crest portion of the thread is formed by the wiper edges 249 of the cutting protrusion 240, particularly in a last cycle.

The Cutting insert 200 of the current disclosure enables a high machining performance which is determined by the maximum load that the active protrusion 240AA can withstand without causing a damage to the tip T_{P}, before it is damaged. Additionally, the insert 200 also can withstand a high leverage exerted on the cutting protrusion without bending and/or twisting and/or dislodging away from the pocket 350. Accordingly, a high accuracy of the operation is maintained in turn improving the surface precision of the work piece 400.

Although the invention has been described with a certain degree of particularity, it should be understood that various modifications and changes can be made without departing from the spirit and scope of the claimed invention. For example, the Cutting insert 200 can have four or six or more cutting portions instead of three. The rake angle, the land angle, the base angle and the face angle can be changed to suit various applications. Furthermore, it will be appreciated that the present invention can also be applied to operations other than threading operations. Instead of clamping screws 265, any known clamping means such as a lever or a pin mechanism can also be used.

It is to be understood that individual features shown or described for one embodiment may be combined with individual features shown or described for another embodiment. It is to be understood that some features are shown or described to illustrate the use of the present disclosure in the context of functional segments and such features may be omitted within the scope of the present disclosure and without departing from the spirit of the present disclosure as defined in the appended claims.

We claim:

1. A cutting tool comprising:
a tool holder having a top face, a bottom face, two opposed longitudinally extending side faces generally parallel to each other, a front end and a back end, said tool holder being provided on one of its side faces with a recess defining an insert pocket confined by a base support surface and side support walls extending upwardly there from;
an indexable cutting insert being releasably secured into said recess, the insert comprising:
a generally polygonal shaped primary body comprising a primary body base, an opposed and similarly-shaped body face with a plurality of flank portions extending there between;
at least one cutting protrusion extending away there from, and merging therewith, the cutting protrusion comprises a protrusion base extending from, and co-planar and merging with the primary body base;
a rake face opposing the protrusion base; and
a protruding flank extending between the protrusion base and the rake face;
wherein the at least one cutting protrusion comprises a tip flat extending rearwardly away from a rake front disposed on the rake face adjacent a protrusion tip and towards a rake root disposed on the rake face adjacent the primary body;
characterized in that, rake face is angled relative to a normal to the primary body base, defining there between a rake angle [Ø] that is smaller than a land angle [Ω] defined between the same normal and the tip flat.

2. The cutting tool of claim 1, wherein the plurality of flank portions comprising at least a rear flank portion generally opposing one of the at least one cutting protrusions and facing away there from, the rear flank portion comprising:
a base flank extending away from the body base towards the body face, and
a top flank extending away from the body face towards the body base to meet at a middle corner,
characterized in that the base flank and the body base define there between a base angle [β] which is larger than a face angle [γ] defined between the top flank and the body base.

3. The cutting tool according to claim 1, wherein at least one of the side support walls and the base support surface of the insert pocket defines a pocket angle (α) there between.

4. The cutting tool according to claim 3, wherein the pocket angle (α) ranges between is 30° and 60° and preferably ranges between 36° to 45° such that a top flank of at least one of the rear flank portions is abutted/locked against the corresponding side support wall.

5. The cutting tool according to claim 1, wherein the protruding flank comprising a first flat flank connected to a second flat flank surface through a central arc shaped flank surface.

6. The cutting tool according to claim 1 and 5, wherein the protrusion tip is defined only by the central arc shaped flank surface of the protruding flank.

7. The cutting tool according to claim 1 further comprising a supporting element defined by a bottom shim surface extending towards side shim walls, the side shim walls extending at a predetermined angle relative to a plane of the bottom shim so as to abut against the one of the support walls of the insert pocket.

8. The cutting tool according to claim 1, wherein the insert is securely engaged within the recess pocket using a clamping means selected from one or more of a center screw, a lever, a pin, or a clamping wedge engageable with a transverse bore in the holder.

9. An indexable cutting insert comprising:
a generally polygonal shaped primary body comprising a primary body base, an opposed and similarly-shaped body face with a plurality of flank portions extending there between;
at least one cutting protrusion extending away there from, and merging therewith, the cutting protrusion comprises a protrusion base extending from, and co-planar and merging with the primary body base;
a rake face opposing the protrusion base; and
a protruding flank extending between the protrusion base and the rake face;
wherein the at least one cutting protrusion comprises a tip flat extending rearwardly away from a rake front disposed on the rake face adjacent a protrusion tip and towards a rake root disposed on the rake face adjacent the primary body;
characterized in that, the rake face is angled relative to a normal to the primary body base, defining there between a rake angle [Ø] that is smaller than a land angle [Ω] defined between the same normal and the tip flat.
